(19) United States
(12) Patent Application Publication
(10) Pub. No.: US 2005/0006833 A1
(43) Pub. Date: Jan. 13, 2005

(54) Vibration isolator for a ceiling fan

(76) Inventor: Shyue-Lin Hsieh, Nantou City (TW)

Correspondence Address: Troxell Law Office PLLC, Suite 1404, 5205 Leesburg Pike, Falls Church, VA, 22041, US

(21) Appl. No.: 10/615,241

(22) Filed: Jul. 9, 2003

(51) Int. Cl. F16F 1/06

(52) U.S. Cl. 267/166

(57) ABSTRACT

A vibration isolator for a ceiling fan includes a stationary tube, a rotatable tube, a compression spring and a torsional damping device. The rotatable tube is rotatably connected to the stationary tube. The compression spring is mounted between the stationary tube and the rotatable tube to reduce longitudinal vibrations. The torsional damping device is mounted between the stationary tube and the rotatable tube to reduce torsional force. Consequently, the longitudinal vibrations and the torsional forces caused by the ceiling fan will be diminished.

### BACKGROUND OF THE INVENTION

1. Field of the Invention

The present invention relates to a vibration isolator for a ceiling fan, and more particularly to a vibration isolator that can diminish both longitudinal vibrations and torsional forces caused by a ceiling fan mounted on a suspension device.

2. Description of Related Art

With reference to FIG. 6, a ceiling fan (not numbered) that is suspended from a ceiling (90) comprises a motor (91) and blades (not shown). The ceiling fan is attached to the ceiling (90) by a suspension device (not numbered) that comprises a ceiling bracket (80), a support rod (81), a hemispherical connector (82) and bolts (83). The ceiling bracket (80) is bent to form two mounting feet (not numbered) and an inner cavity (not numbered). The ceiling bracket (80) is attached to the ceiling (90) by screwing the bolts (83) through the mounting feet and into the ceiling (90). The ceiling bracket (80) has a bottom (not numbered) and a through hole (not numbered) defined through the bottom and communicating with the inner cavity.

The hemispherical connector (82) has a convex bottom (not numbered) and is rotatably mounted in the through hole before the ceiling bracket (80) is attached to the ceiling (90). The convex bottom of the hemispherical connector (82) extends partially out of the through hole. The support rod (81) has a top end (not numbered) and a bottom end (not numbered). The top end of the support rod (81) is connected to the hemispherical connector (82). The bottom end of the supporting rod (81) is connected to the motor (91) to suspend the ceiling fan from the ceiling (90).

When the motor (91) rotates the blades, a torsional force will be created by the rotation and transmitted to the ceiling bracket (80) through the support rod (81). The rotation will also cause vibrations if the blades are even slightly unbalanced. Installing the blades so the blades are perfectly balanced is extremely difficult to achieve in a mass production environment. Consequently, vibrations of some degree will always be generated by the rotation of the blades and will be transmitted to the ceiling bracket (80) in a longitudinal direction.

When the support rod (81) is long such that the motor (91) is far away from the ceiling bracket (80), the transmitted vibrations and forces caused by the blades will be amplified at the ceiling bracket (80). Long-term vibrations and torsional forces on the ceiling bracket (80) loosen the bolts (83) and fatigue the ceiling bracket (80). The ceiling fan will become unsafe and can be potentially hazardous to people near the ceiling fan.

To attenuate the vibrations, damping material such as sponge (not shown) is mounted between the mounting feet and the ceiling (90). However, tightening the bolts (83) excessively will compress the damping material and cause the damping material to be ineffective. Furthermore, damping material on or near a ceiling is subjected to rising heat that will deteriorate the damping material and cause it to crumble after extensive usage and eventually completely lose its effectiveness.

To overcome the shortcomings, the present invention provides an isolator for a ceiling fan to mitigate or obviate the aforementioned problems.

### SUMMARY OF THE INVENTION

The main objective of the invention is to provide a vibration isolator for a ceiling fan, which can diminish both longitudinal vibrations and torsional forces such that the ceiling fan can be operated safely and reliably.

Other objectives, advantages and novel features of the invention will become more apparent from the following detailed description when taken in conjunction with the accompanying drawings.

### BRIEF DESCRIPTION OF THE DRAWINGS

FIG. 1 is a side plan view in partial section of a vibration isolator in accordance with the present invention for a ceiling fan;

FIG. 2 is a cross sectional top plan view of the vibration isolator along line 2-2 in FIG. 1;

FIG. 3 is a side plan view in partial section of an alternative embodiment of a vibration isolator in accordance with the present invention for a ceiling fan;

FIG. 4 is an enlarged cross sectional side plan view of the vibration isolator in sector 4 in FIG. 3;

FIG. 5 is an operational side plan view of the isolator in FIG. 1; and

FIG. 6 is a side plan view in partial section of a conventional ceiling bracket in accordance with the prior art.

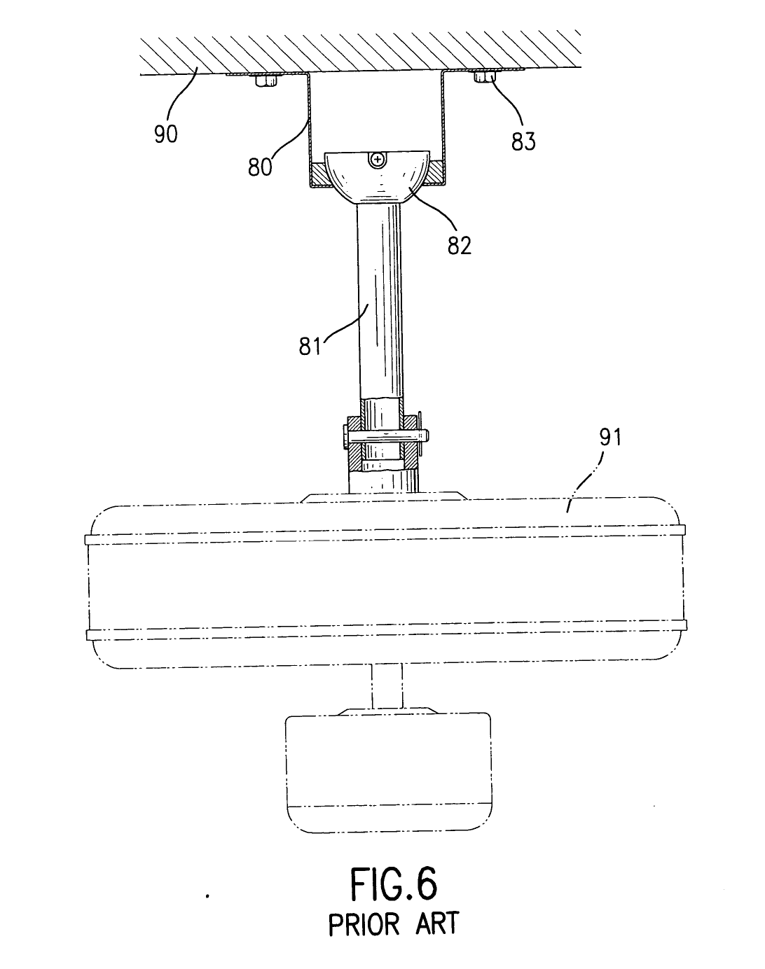

### DETAILED DESCRIPTION OF PREFERRED EMBODIMENT

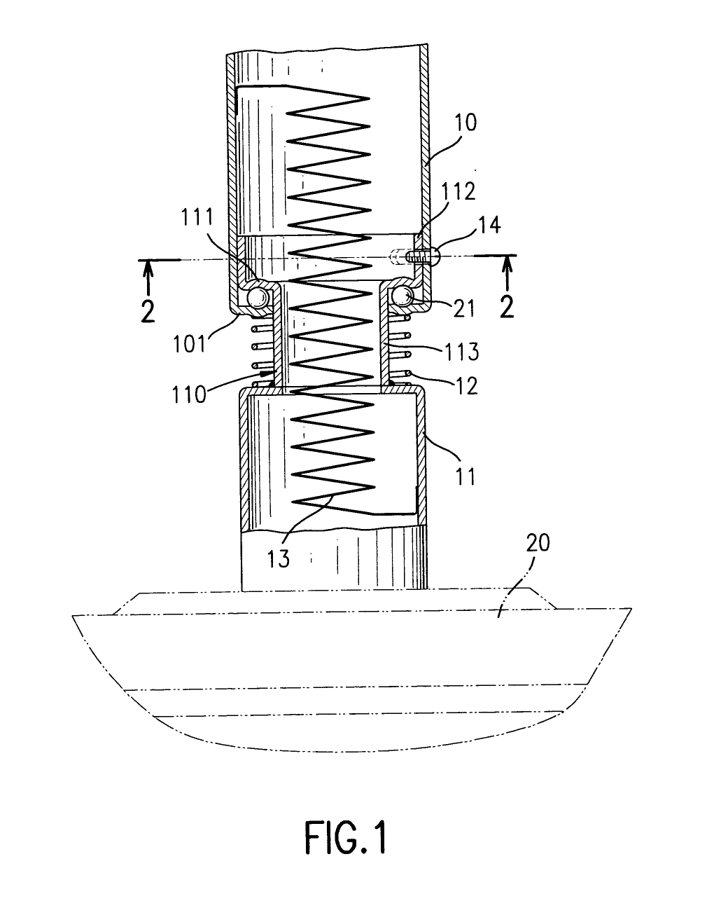

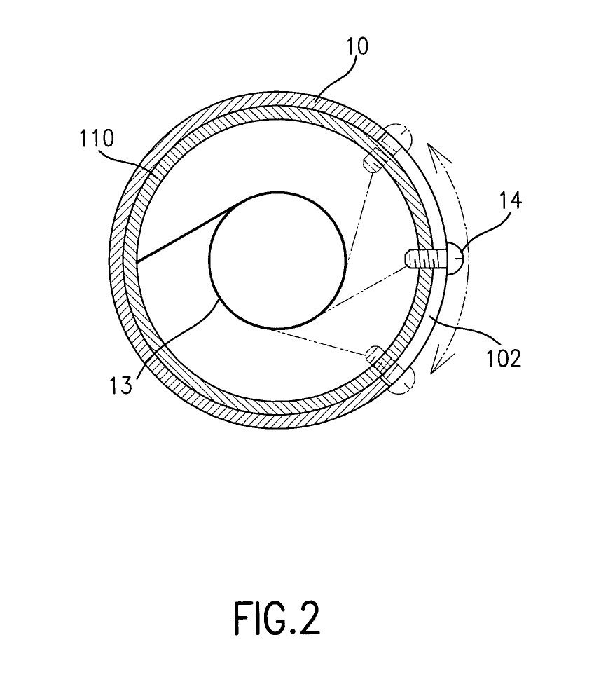

With reference to FIGS. 1 and 2, a vibration isolator (not numbered) in accordance with the present invention comprises a stationary tube (10), a rotatable tube (11), a compression spring (12) and a torsional damping device (not numbered).

The stationary tube (10) has a top end (not shown), a bottom end (not numbered), a sidewall (not numbered), a diameter (not numbered), a bottom edge (101) and an annular slot (102). The top end of the stationary tube (10) can be directly connected to a ceiling (not shown) or be connected to a mounting device (not shown) that is attached to the ceiling. The bottom edge (101) is formed radially inward at the bottom end of the stationary tube (10) to define a first opening (not numbered). The annular slot (102) is defined in the sidewall of the stationary tube (10) near the bottom end and has a width (not numbered).

The rotatable tube (11) is shorter than the stationary tube (10) and has a top end (not numbered), a bottom end (not numbered), a top edge (not numbered) and a sidewall (not numbered). The top edge is formed radially inwardly at the top end of the rotatable tube (11) to define a second opening (not numbered) corresponding to the first opening in the stationary tube (10). The bottom end of the rotatable tube (11) is connected to a motor (20) of a ceiling fan (not shown).

The torsional damping device is mounted between the stationary tube (10) and the rotatable tube (11) to connect the rotatable tube (11) to the stationary tube (10). The torsional damping device comprises a connecting tube (110), a coil spring (13), rollers (not numbered) and a positive limit (14). The connecting tube (110) has an enlarged open tubular head (112), a narrow tubular neck (113), a top end (not numbered) and a bottom end (not numbered), is securely attached to the top edge of the rotatable tube (11) and is rotatably mounted through the first opening in the bottom end of the stationary tube (10). The enlarged open tubular head (112) of the connecting tube (110) has a diameter (not numbered) and a shoulder (111). The diameter of the enlarged open tubular head (112) is slightly smaller than the diameter of the stationary tube (10) to allow the connecting tube (110) to rotate inside the stationary tube (10). The narrow tubular neck (113) has an open bottom end (not numbered). The open bottom end of the narrow tubular neck (113) passes through the first opening in the bottom end of the stationary tube (10), and is attached to the top edge of the rotatable tube (11) by welding or other means. The compression spring (12) is mounted around the narrow tubular neck (113) between the bottom edge (101) of the stationary tube (10) and the top edge of the rotatable tube (11).

The shoulder (111) is rotatably supported by the bottom edge (101) of the stationary tube (10). Furthermore, to reduce friction between the shoulder (111) and the bottom edge (101), rollers such as rolling balls (21) are rotatably mounted between the shoulder (111) and the bottom edge (101). The coil spring (13) has a first end (not numbered) and a second end (not numbered). The first end of the coil spring (13) is securely attached to the sidewall of the stationary tube (10). The second end of the coil spring (13) passes through the connecting tube (110) and the second opening, extends into the rotatable tube (11) and is securely attached to the sidewall of the rotatable tube (11).

The compression spring (12) absorbs and diminishes longitudinal vibrations, and the coil spring (13) diminishes the torsional forces. The compression spring (12) and the coil spring (13) reduce or eliminate the transmission of the longitudinal vibrations and torsional forces to the stationary tube (10).

The positive limit (14) is attached to the enlarged open tubular head (112) and has an outside end (not numbered) and a diameter (not numbered). The outside end of the positive limit (14) is slidably mounted in the annular slot (102) of the stationary tube (10). The diameter of the positive limit (14) is smaller than the width of the annular slot (102) to provide a gap (not numbered) between the annular slot (102) and the positive limit (14) for a slight movement of the rotatable tube (11) in a longitudinal direction. In addition, the positive limit (14) limits how much the connecting tube (110) and the rotatable tube (11) will rotate.

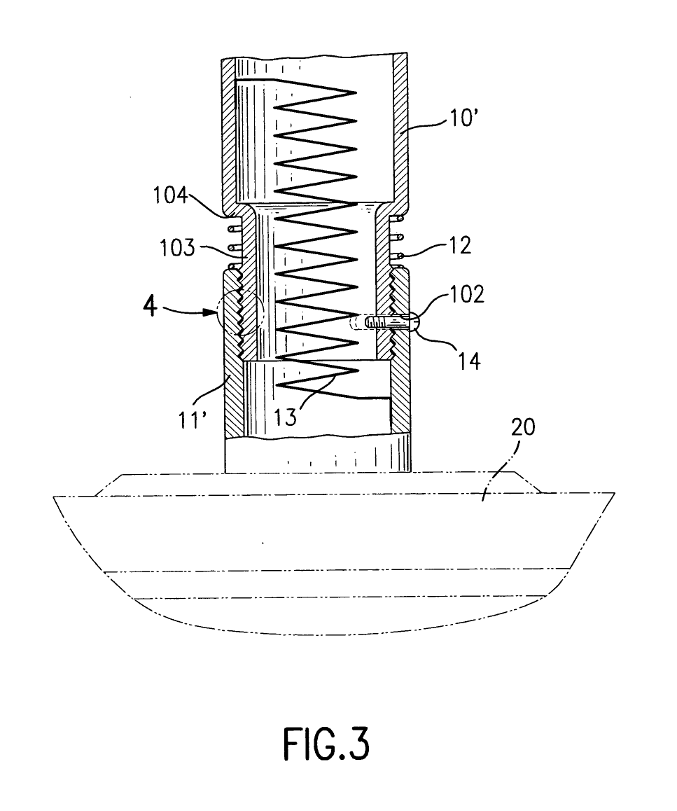

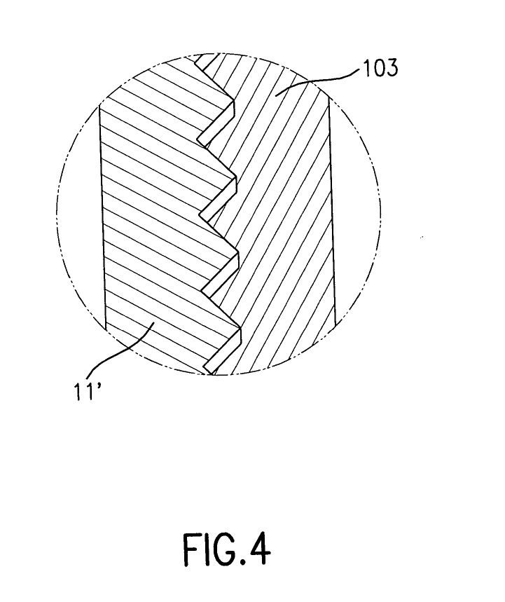

With reference to FIGS. 3 and 4, a second embodiment of the vibration isolator in accordance with the present invention comprises a modified stationary tube (10′), a modified rotatable tube (11′), a modified torsional damping device (not numbered) and a compression spring (12). The stationary tube (10′) has a tubular body (not numbered), a sidewall (not numbered), a narrow neck (103) and a shoulder (104). The tubular body has a top end (not shown), a bottom end (not numbered) and a diameter (not numbered). The narrow neck (103) has a top end (not numbered), a bottom end (not numbered) and an exterior thread (not numbered) having a pitch diameter (not numbered). The shoulder (104) is integrally between the bottom end of the tubular body and the top end of the narrow neck (103).

The rotatable tube (11′) is rotatably connected to the stationary tube (10′) and has a top end (not numbered), a sidewall (not numbered), an annular slot (102) and an internal thread (not numbered). The annular slot (102) is defined in the sidewall of the rotatable tube (11′) near the top end and has a width (not numbered). The internal thread is defined on the sidewall of the rotatable tube (11′) and has a pitch diameter (not numbered) larger than the pitch diameter of the exterior thread on the narrow neck (103) to allow the narrow neck (103) to retract into or extend out of the rotatable tube (11′).

The compression spring (12) is mounted around the narrow neck (103) between the shoulder (104) on the modified stationary tube (10′) and the top end of the rotatable tube (11′).

The torsional damping device comprises a coil spring (13) and a positive limit (14). The coil spring (13) is mounted inside the stationary tube (10′) and the rotatable tube (11′) and has a first end (not numbered) and a second end (not numbered). The first end of the coil spring (13) is attached inside the sidewall of the stationary tube (10′). The second end of the coil spring (13) passes through the narrow neck (103), extends out of the narrow neck (103) and is attached inside the sidewall of the rotatable tube (11′). The positive limit (14) is attached to the narrow neck (103) and has an outside end (not numbered) and a diameter (not numbered). The outside end of the positive limit (14) is slidably mounted in the annular slot (102) in the rotatable tube (11′). The diameter of the positive limit (14) is smaller than the width of the annular slot (102) to define a gap (not numbered) between the positive limit (14) and the annular slot (102) to do a function as previously described.

When the blades of the ceiling fan are rotated, the rotation of the blades will generate a torsional force that tends to rotate the rotatable tube (11′). The rotatable tube (11′) will be moved upwardly by the torsional force through the threads, but the coil spring (13) will reduce the effect of the torsional force. The positive limit (14) restricts the rotation of the rotatable tube (11′) and holds the rotatable tube (11′) on the narrow neck (103).

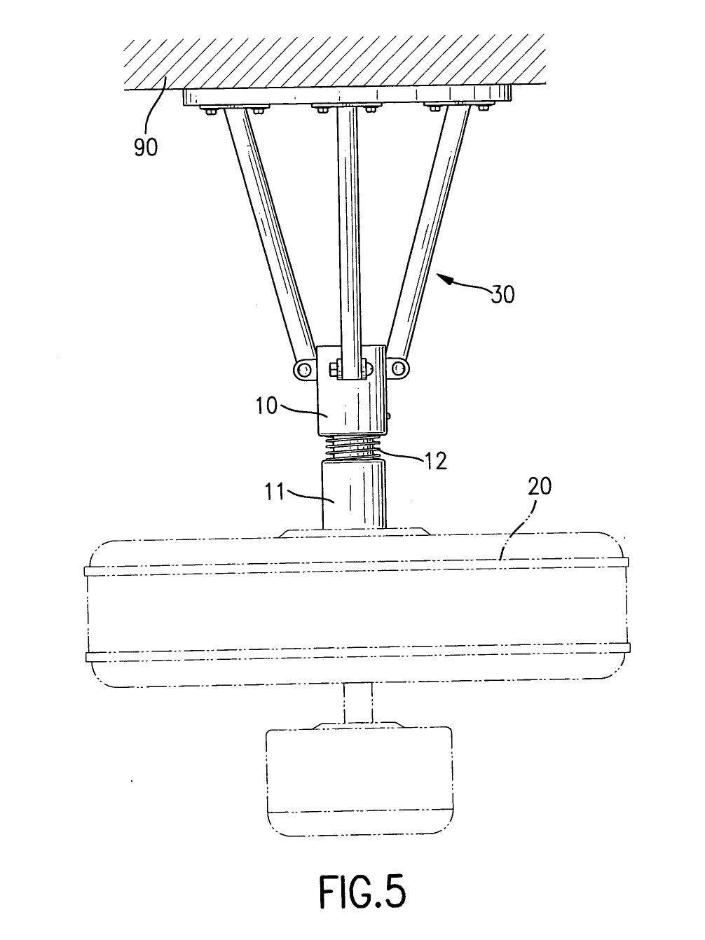

With reference to FIG. 5, the top end of the stationary tube (10) may be connected to a tripod ceiling bracket (30). The tripod ceiling bracket (30) can provide a robust support for the ceiling fan. The longitudinal vibrations will be diminished by the compression spring (12). The torsional force will be reduced by the coil spring (13). The longitudinal vibrations and the torsional forces will be attenuated and will not be completely transmitted to the tripod ceiling bracket (30). The ceiling fan will be firmly held on and suspended from the ceiling by the tripod ceiling bracket (30). Therefore, the ceiling fan will be operated safely and reliably.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A vibration isolator for a ceiling fan, and the vibration isolator comprising:
a stationary tube having a bottom end, a diameter and a sidewall;
a rotatable tube rotatably connected to the stationary tube and having a top end and a sidewall, the top end of the rotatable tube rotatably connected to the bottom end of the stationary tube;
a torsional damping device connecting the stationary tube to the rotatable tube to reduce torsional forces; and
a compression spring mounted between the bottom end of the stationary tube and the top end of the rotatable tube to reduce longitudinal vibrations.

2. The vibration isolator as claimed in claim 1, wherein
the stationary tube further has a bottom edge formed inward at the bottom end of the stationary tube and forming a first opening,
the rotatable tube further has a top edge formed inward on the top end of the rotatable tube and forming a second opening, and
the torsional damping device comprises
a connecting tube rotatably mounted in the stationary tube, and having an enlarged open tubular head with a diameter, a shoulder and a narrow tubular neck, the diameter of the enlarged open tubular head being slightly smaller than the diameter of the stationary tube, the narrow tubular neck having a bottom end passing through the first opening in the bottom end of the stationary tube, extending out of the first opening and attached to the top edge of the rotatable tube;
multiple rollers rotatably mounted between the bottom edge and the shoulder of the connecting tube; and
a coil spring mounted in the stationary tube and having a first end attached inside the sidewall of the stationary tube, and a second end passing through the connecting tube and the second opening in the rotatable tube, extending into of the rotatable tube and attached inside the sidewall of the rotatable tube.

3. The vibration isolator as claimed in claim 1, wherein
the stationary tube further has a shoulder, a narrow neck and an exterior thread, the narrow neck has a top end, the shoulder is integrally formed between the bottom end of the stationary tube and the top end of the narrow neck, and the exterior thread is defined around the narrow neck and has a pitch diameter,
the top end of the rotatable tube is rotatably connected to the stationary tube and has an internal thread defined on the sidewall of the rotatable tube, the internal thread has a pitch diameter larger than the pitch diameter of the exterior thread on the narrow neck, and
the torsional damping device comprises
a coil spring mounted in the stationary tube and having a first end attached inside the sidewall of the stationary tube, and a second end passing through the narrow neck, extending out of the narrow neck and attached inside the sidewall of the rotatable tube.

4. The vibration isolator as claimed in claim 2, wherein the stationary tube further has an annular slot with a width defined in the sidewall of the stationary tube near the bottom end of the stationary tube, and the torsional damping device further comprises a positive limit attached to the enlarged open tubular head, and the positive limit having an outside end slidably mounted in the annular slot and a diameter being smaller than the width of the annular slot to define a gap between the positive limit and the annular slot.

5. The vibration isolator as claimed in claim 3, wherein the rotatable tube further has an annular slot with a width defined in the sidewall of the rotatable tube near the top end of the rotatable tube, and the torsional damping device further has a positive limit attached to the narrow neck, and the positive limit having an outside end slidably mounted in the annular slot and a diameter being smaller than the width of the annular slot to define a gap between the positive limit and the annular slot.
